(19) United States
(12) Patent Application Publication
(10) Pub. No.: US 2006/0168358 A1
(43) Pub. Date: Jul. 27, 2006

(54) Storage control system

(75) Inventors: Pei-Chuan Liang, Hsinchu City (TW); Chin-Hsiang Wang, Hsinchu City (TW); Yee-Lu Zhaog, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/149,364

(22) Filed: Jun. 10, 2005

(30) Foreign Application Priority Data
Jan. 25, 2005 (TW) 094102145

(51) Int. Cl. G06F 3/00

(52) U.S. Cl. 710/8

(57) ABSTRACT

A storage control system connects to a host with a standard device driver. The control system includes a first bus, a host interface controller, a memory, a controller and a plurality of device interface controllers. The controller controls the host interface controller and the device interface controllers through the first bus for writing data sent by the host to respective disk drives in accordance with a type of disk array, or reading data from the respective disk drives in accordance with the type of the disk array and sending the data read to the host, thereby emulating the disk array as a single disk drive.

### BACKGROUND OF THE INVENTION

1. Field of the Invention

The invention relates to the technical field of disk storage and, more particularly, to a system of emulating a serial ATA (SATA) disk array as a single SATA disk drive.

2. Description of Related Art

Typical digital electric appliances (e.g., digital versatile disk (DVD) recorders, Karaoke, electric accompaniment machines, and the like) use hard disks to store image data. The hard disks are embedded in the digital electric appliances and cannot be expanded easily due to the fixed storage capacities at ex-factory. In addition, the embedded operating systems used by the factories are different, and thus it is required to appropriately modify an operating system and storage device for use by different factories. Moreover, a damaged storage device has to be sent back to its original factory for replacement.

Accordingly, a prior small computer system interface (SCSI) disk array is used to overcome the problem that the storage capacity is not easily expanded. However, such a way requires an additional SCSI control card, which relatively increases the cost. U.S. Pat. No. 6,772,108 discloses a disk array controller 50, which is connected to a PCI bus 12, with emulated advanced technology attachment (ATA) ports, as shown in a block diagram of FIG. 1. The system emulates the disk array controller 50 as the ATA ports such that the problem of the storage capacity not easily expanded is overcome by increasing the number of integrated drive electronics (IDE) drives. This does not require the additional SCSI control card but the ATA ports cannot support hot-plug. Thus, the system needs be shut down to add a new IDE drive when a user desires to expand the storage capacity.

Therefore, it is desirable to provide an improved storage system to mitigate and/or obviate the aforementioned problems.

### SUMMARY OF THE INVENTION

The object of the invention is to provide a storage control system, which can overcome the prior problem that the storage capacity is not easily expanded and obtain the function of hot-plug to thus improve the convenience of usage.

In accordance with the first aspect of the present invention, there is provided a storage control system, which connects to a host as a standard SATA disk device. The control system includes a first bus, a host interface controller, a memory, a controller and a plurality of device interface controllers. The first bus receives and transmits data. The host interface controller connects to the host for receiving commands and data sent by the host or sending the data to the host, and the first bus. The memory connects to the host interface controller for temporarily store the commands and the data sent by the host, and the first bus. The controller connects to the memory for accessing the commands stored in the memory, and the first bus. Each device interface controller has one end connected to the first bus for sending the data to the memory or receiving the data from the memory and the other end connected to a disk drive for forming the disk drives as a disk array. The controller controls the host interface controller and the device interface controllers through the first bus for writing the data sent by the host to the respective disk drives in accordance with a type of the disk array, or for reading the data from the respective disk drives in accordance with the type of the disk array and sending the data read to the host. Thus, the disk array is emulated as a disk drive.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical disk array controller with emulated ATA ports;

FIG. 2 is a block diagram of a storage control system in accordance with the invention;

FIG. 3 is a schematic diagram of data write-in when two disk drives are configured to disk striping in accordance with the invention;

FIG. 4 is a schematic diagram of data write-in when two disk drives are configured to disk mirroring in accordance with the invention;

FIG. 5 is a schematic diagram of data readout when two disk drives are configured to disk mirroring in accordance with the invention;

FIG. 6 is a schematic diagram of data write-in when three disk drives are configured to RAID5 in accordance with the invention; and

FIGS. 7A, 7B and 7C are schematic diagrams of executing hot-plug in accordance with the invention.

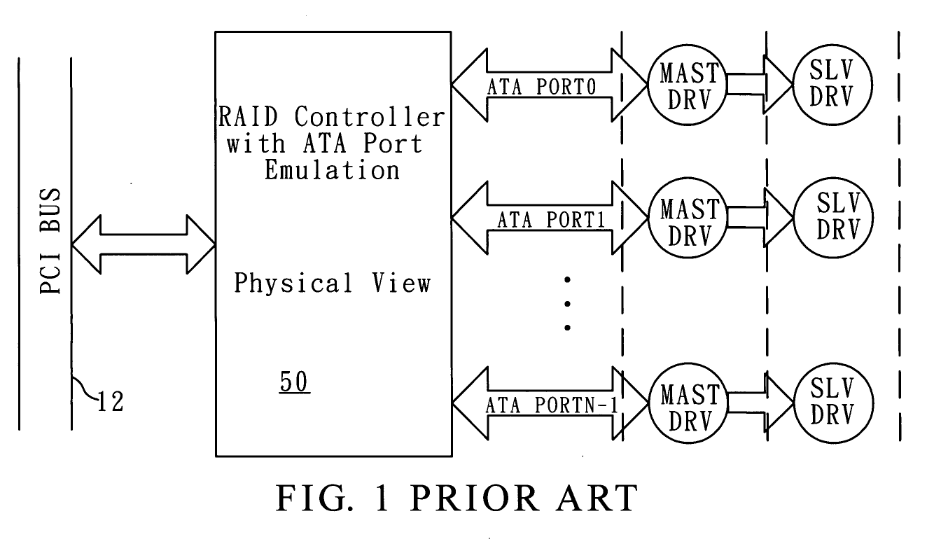

### DETAILED DESCRIPTION OF THE PREFERRED EMBODIMENT

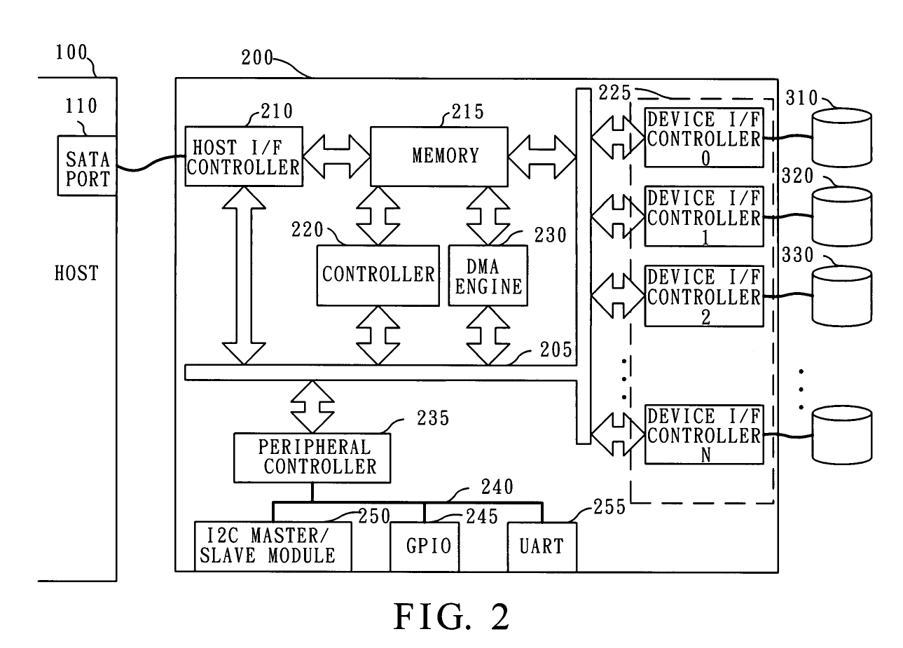

FIG. 2 is a block diagram of a storage control system 200 in accordance with the invention, which is connected to a host 100 using a Serial ATA host adapter with a SATA port 110 to overcome the prior problem of inexpansible storage capacity and to provide hot-plug support, thereby improving the convenience of usage. The control system 200 includes a first bus 205, a host interface controller 210, a memory 215, a controller 220, a plurality of device interface controllers 225, a direct memory access (DMA) engine 230, a second bus 240, a peripheral controller 235, a general-purpose input/output (GPIO) module 245, an I2C master/slave module 250 and a universal asynchronous receiver/transmitter (UART) module 255.

The first bus 205 receives and transmits data. The host interface controller 210 is a SATA (Serial ATA) device port controller, which connects to a SATA port 110 of the host through a SATA cable for receiving commands and data sent by the host 100 or sending the data to the host 100, and the first bus 205.

The memory 215 connects to the host interface controller 210 for temporarily store the commands and the data sent by the host 100, and the first bus 205. The direct memory access engine 230 connects to the memory 215 for controlling the access of the memory 215. The controller 220 connects to the first bus 205 for controlling the DMA engine 230 through the first bus 205 and the memory 215 for accessing the commands stored in the memory 215 that are sent by the host 100.

Each of the device interface controller 225 is a SATA host adapter, which has one end connected to the first bus 205 for sending the data to the memory 215 or receiving the data from the memory 215, and the other end connected to a SATA disk drive (310, 320 . . . ) for forming the disk drives as a disk array.

The controller 220 controls the host interface 210 controller and the device interface controllers 225 through the first bus 205 for writing the data sent by the host to the respective disk drives (310, 320 . . . ) in accordance with a type of the disk array, or reading the data from the respective disk drives (310, 320 . . . ) in accordance with the type of the disk array and sending the data read to the host 100 to thus emulate the drive array as a drive.

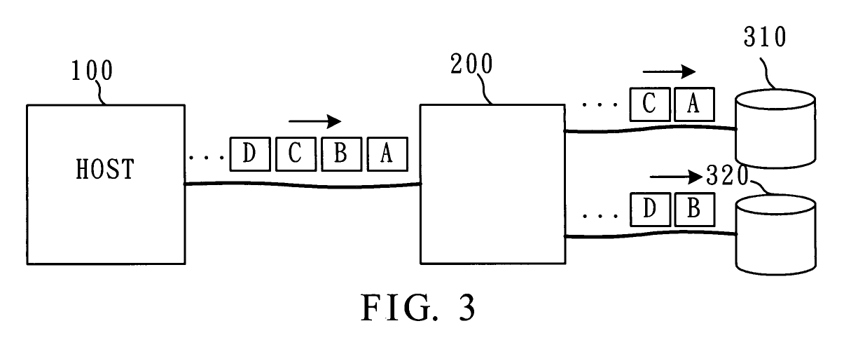

FIG. 3 is a schematic diagram of data write-in when two disk drives 310, 320 are configured to be disk striping in accordance with the invention. When the controller 220 receives a write-in command sent by the host 100, it sends the command to the appropriate disk drives with the linear block address (LBA) contained in the command, and controls the DMA engine 230 to transfer data blocks between the host 100 and the disk drives 310, 320 sequentially.

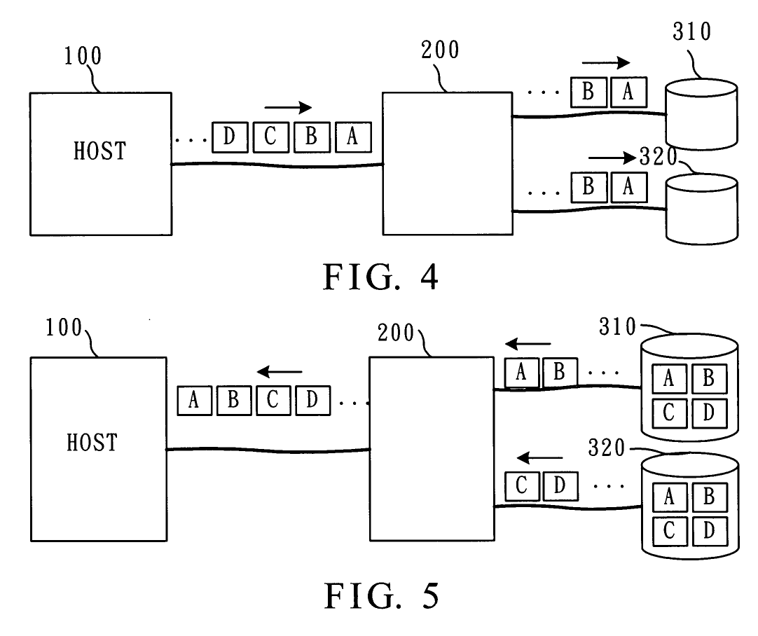

FIG. 4 is a schematic diagram of data write-in when the disk drives 310, 320 are configured to be disk mirroring (RAID 1) in accordance with the invention. The controller 220 receives the write-in command sent by the host 100 and also sends the command to the disk drives 310, 320, and controls the DMA engine 230 to receive data blocks sent by the host 100 and to send the blocks to the disk drives 310, 320.

FIG. 5 is a schematic diagram of data readout when the two disk drives 310, 320 are configured to be disk mirroring in accordance with the invention. When the controller 220 receives a readout command sent by the host 100, it changes the command in order to read data blocks respectively from the disk drives 310, 320 for better efficiency. Then, the controller 220 controls the DMA engine 230 to receive the data blocks sent by the disk drives 310, 320 sequentially and to send the data blocks received to the host 100.

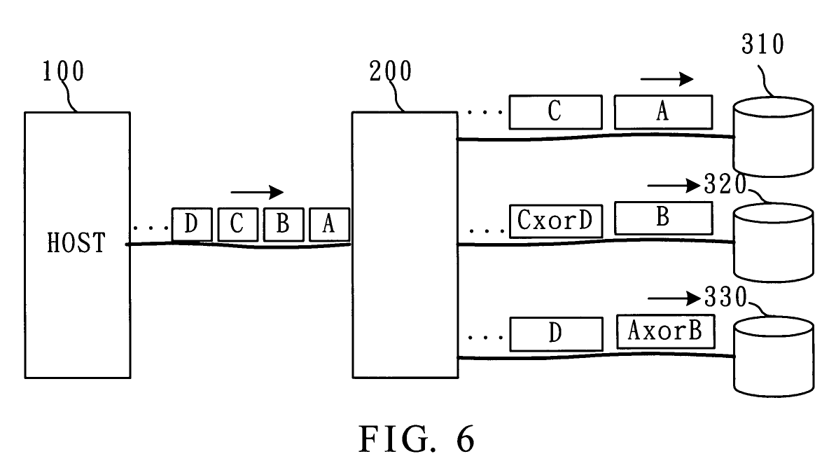

FIG. 6 is a schematic diagram of data write-in when three disk drives 310, 320, 330 are configured to be a RAID5 configuration in accordance with the invention. When the controller 220 receives a command sent by the host 100, it changes linear block address (LBA) and block count contained in the command. The controller 220 sends the changed linear block address and block count to the disk drives 310, 320, 330 respectively, and controls the DMA engine 230 to transfer data blocks sequentially between the host and two of the disk drives 310, 320, 330. Them, the controller 220 temporarily stores the data blocks in the memory 215, and sends the data blocks to the remaining one 310, 320 or 330 after an XOR operation is performed.

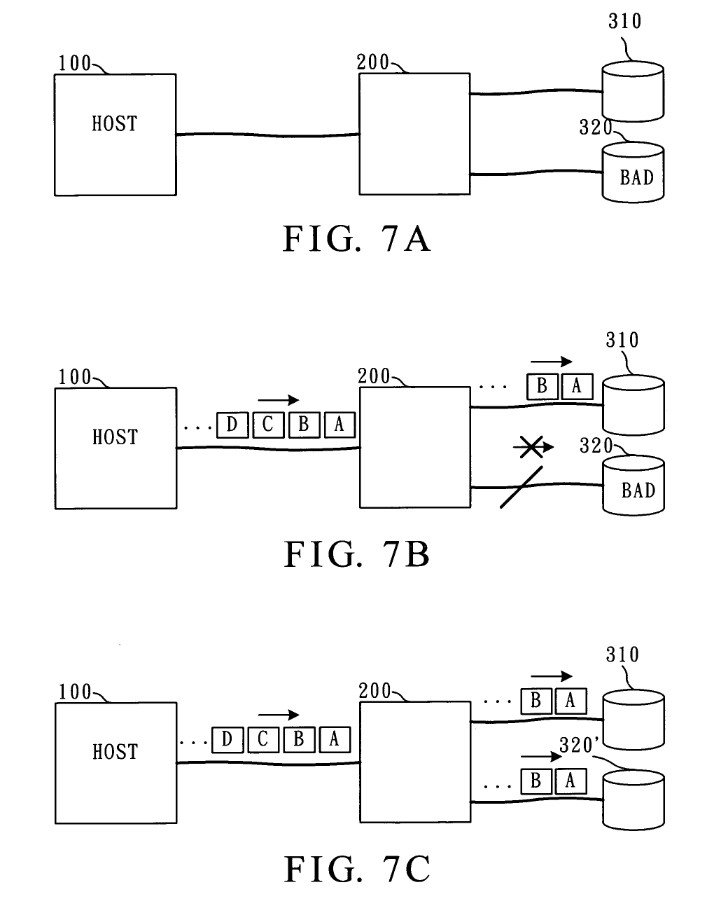

FIGS. 7A, 7B and 7C are schematic diagrams of executing hot-plug in accordance with the invention. When the controller 220 detects the damaged disk drive 320, the damaged disk drive 320 is removed. However, if the disk array containing the damaged disk drive 320 is configured as a fault tolerant mode, i.e., RAID 1 or RAID 5, the host 100 can continue data access without affecting by the damaged drive 320. When the capacity of the disk array is expanded, the storage control system 200 generates an off-line signal and an on-line request signal in order to make the host 100 re-checks the drives. After the damaged drive 320 is replaced by a new one, the host 100 can still operate as usual.

The second bus 240 can receive and transmit data for a plurality of peripheral devices. The peripheral controller 235 has one end connected to the first bus 205 and the other end connected to the second bus 240. The GPIO module 245 is connected to the second bus 240 such that the controller 220 can access a peripheral device through the GPIO module 245.

The I2C master/slave module 250 connects to the second bus 240 such that the controller 220 can access an I2C bus through the I2C master/slave module 250. The UART module 255 connects to the second bus 240 such that the controller 220 can access a UART bus through the UART module 255.

The controller 220 can communicate with other peripheral devices through the GPIO module 245, I2C master/slave module and UART module 255. For example, if a temperature sensor with an I2C interface is connected to the I2C master/slave module 250, the I2C master/slave module 250 can read a current temperature and send the temperature to the host 100 when the controller 220 receives a special command sent by the host 100.

In view of the foregoing, it is known that the storage control system 200 emulates a disk array as a single disk drive. The disk array can be a typical RAID or other configuration. Because the host 100 regards the disk array as a single disk drive, there is no need to provide different device drivers under different operation system. In addition, the SATA standard can support the functions of hot-plug and external connection. Accordingly, the storage control system 200 can report a current configuration of the disk array at any time, and a damaged drive can be replaced when the host 100 is still in operating, which does not damage the host 100 or any other hardware of the system 200.

Although the present invention has been explained in relation to its preferred embodiment, it is to be understood that many other possible modifications and variations can be made without departing from the spirit and scope of the invention as hereinafter claimed.

What is claimed is:

1. A storage control system, which connects to a host with a standard disk device driver, the system comprising:
a first bus, which receives and transmits data;
a host interface controller, which electrically connects to the host for receiving commands and data sent by the host or sending the data to the host, and connects to the first bus;
a memory, which connects to the host interface controller for temporarily store the commands and the data sent by the host, and connects to the first bus;
a controller, which connects to the memory for accessing the commands stored in the memory, and connects to the first bus; and
a plurality of device interface controllers, each of which has one end connected to the first bus for sending the data to the memory or receiving the data from the memory, and the other end connected to a disk drive for forming the disk drives as a disk array;
wherein the controller controls the host interface controller and the device interface controllers through the first bus for writing the data sent by the host to the respective disk drives in accordance with a type of the disk array, or for reading the data from the respective disk drives in accordance with the type of the disk array and sending the data read to the host to thus emulate the disk array as a disk drive.

2. The system as claimed in claim 1, further comprising a direct memory access engine, which connects to the memory for controlling an access of the memory.

3. The system as claimed in claim 2, wherein the direct memory access engine connects to the first bus such that the controller controls the direct memory access engine through the first bus.

4. The system as claimed in claim 1, wherein the host interface controller is a serial AT attachment (SATA) port controller connecting to a SATA port of the host.

5. The system as claimed in claim 1, wherein the device interface controllers are a SATA port controller respectively connecting to a SATA disk drive.

6. The system as claimed in claim 1, further comprising:
a second bus, which receives and transmits data;
a peripheral controller, which has one end connected to the first bus and the other end connected to the second bus; and
a general-purpose input/output module, which connects to the second bus such that the controller accesses a peripheral device through the general-purpose input/output module.

7. The system as claimed in claim 6, further comprising an I2C master/slave module, which connects to the second bus such that the controller accesses an I2C bus through the I2C master/slave module.

8. The system as claimed in claim 6, further comprising a universal asynchronous receiver/transmitter (UART) module, which connects to the second bus such that the controller accesses a UART bus through the UART module.

9. The system as claimed in claim 1, wherein the disk drive array is a RAID1 disk array.

10. The system as claimed in claim 1, wherein the disk drive array is a RAID5 disk array.
